(19) United States
(12) Patent Application Publication
(10) Pub. No.: US 2007/0193313 A1
(43) Pub. Date: Aug. 23, 2007

(54) Anti-theft tag

(76) Inventor: Yu-Chi Tsai, Taichung City (TW)

Correspondence Address: EGBERT LAW OFFICES, 412 MAIN STREET, 7TH FLOOR, HOUSTON, TX, 77002, US

(21) Appl. No.: 11/356,863

(22) Filed: Feb. 21, 2006

(51) Int. Cl. E05B 65/00

(52) U.S. Cl. 70/57.1

(57) ABSTRACT

The present invention provides a structure of an anti-theft tag, and more particularly to an enhanced tag that connects to the tool to prevent theft of the tool. The invention primarily uses a spring part that is formed on one side wall of the pieced part of a tag, and the positioning part of the through slot of the tool can be locked in to the positioning end of the tag. Two locking ends are formed on both ends of the locking component, and the two locking ends can be clipped to both sides of the tag, so that the two locking ends of the locking component can be locked in the clip slot inside the locking slot. The tool and the tag of the present invention are inseparable, which achieves an anti-theft effect.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an anti-theft tag and more particularly to an enhanced tag that connects to the tool to prevent theft.

### BACKGROUND OF THE INVENTION

In response to the market demand, regular hardware stores offer consumers all types of tools or products by mass retailing, and different types of tools are displayed by hanging. The most common method for the hardware stores to display the tools is hanging the tools on the rack with a tag. The most commonly known tool, such as the cylinder or rod for pneumatic tools, are displayed on the rack by tag. Also, the product's specification, name or anti-theft bar code may be placed on the surface of the tag for the consumers to identify the types and styles. However, theft incidents occur endlessly in today's world, and the anti-theft monitor used by regular stores have some blind spots. Therefore, thieves often break the tag and hide the tool on them, so it is hard to detect the stolen goods even they pass through the detector, and many business owners are troubled by the inability to prevent thefts. For these reasons, the industry had tried to develop a structure for an anti-theft tag. However, because the internal part of the structure had been too complicated and because the cost is too high, causing burden on the industry, the product is sold to the consumer in the end, the consumers bear the burden.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The present invention provides a tag 10 that is connected in one piece by the suspension part 11 and the pieced part 12. One side of the pieced part 12 of the tag 10 forms a spring part 15 that is leaning slightly, and the top of the spring part 15 is separated from the top wall of the pieced part 12. The internal part of the pieced part 12 is hollow, which forms a space for the spring part 15 to move, and a reinforced rib 16 is placed in the middle of the pieced part 12 to strengthen its strength. A through slot 21 and a blocking part 23 are formed on the top of the tool 20, and the through slot 21 of the tool 20 can be connected to the pieced part 12 of the tag 10. The blocking part 23 blocks the blocking ends 13 on both sides of the tag 10, and a positioning part 22 that is corresponding to the positioning end 14 of the tag is formed on the pre-determined position on the internal wall of the through slot 21. Thus, the positioning part 22 of the through slot 21 of the tool 20 is locked to the positioning end 14 of the tag 10, and two locking ends 31 are formed on both sides of the locking component 30, so that when the locking component 30 is positioned in the locking slot 17 of the tag 10, the two locking ends 31 of the locking component 30 can be locked to the clipping position on both sides of the tag 10. Thus, the two locking ends 31 of the locking component 30 can be locked into the two clip slot 18 inside the locking slot 17. When the locking component 30 is connected to the locking slot 17 of the tag 10, the limiting space 32 of the locking component 30 can be connected to the limiting part 19 of the reinforced rib 16 of the tag 10. When the locking component 30 is connected to the tag 10, it can limit and lock the two ends to improve the disadvantages existing in the structure of conventional anti-theft tag, such as over-complication, and high cost mentioned in the prior art. Compared to the prior art, the present invention makes the tool 20 and the tag 10 inseparable, which achieves the anti-theft effect.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the present invention.

FIG. 2 shows an assembled perspective view of the present invention.

FIG. 3 shows the section view across line X-X of FIG. 2.

FIGS. 4-6 show cross-sectional view of the operation of the present invention.

FIGS. 7-8 show the another cross-sectional view of the operation of another embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

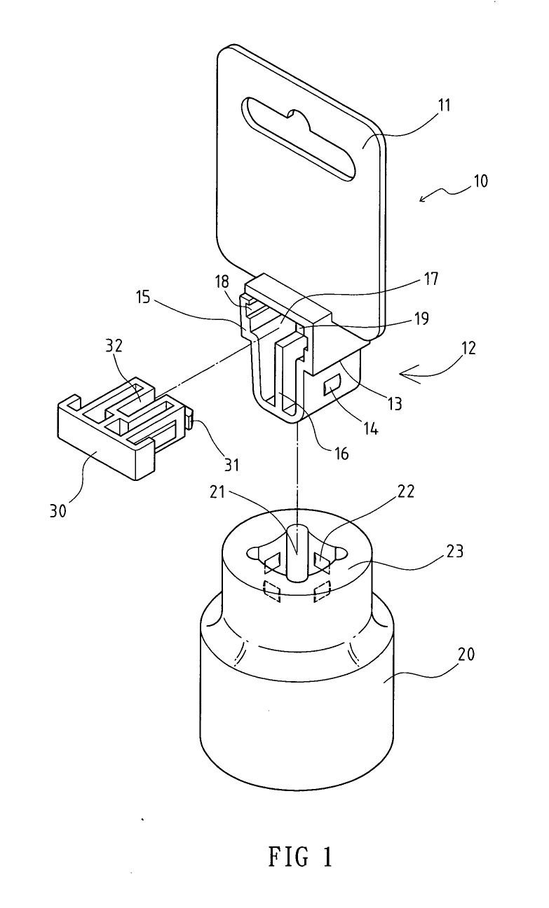

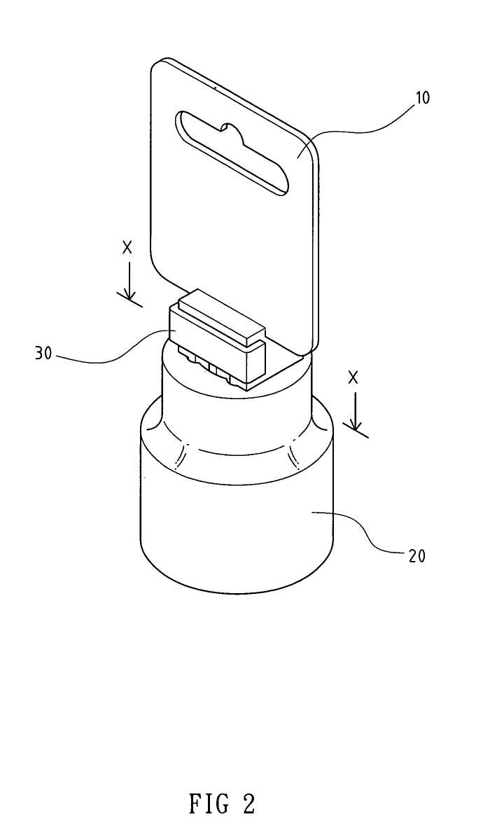

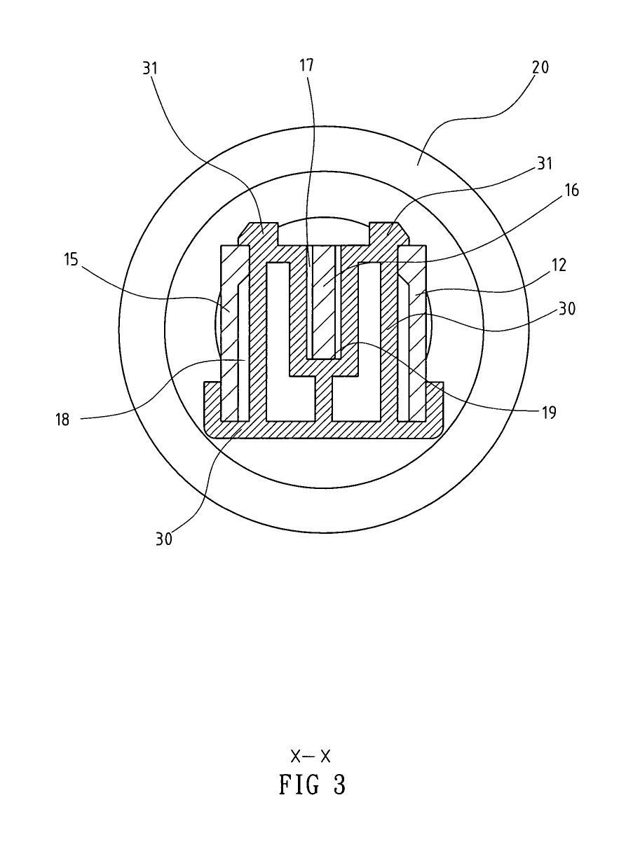

Shown in FIGS. 1-6 are the preferred embodiment of the structure for anti-theft tag, except that this embodiment is for description purpose only, it is not limited by this structure when applying for the patent.

First, as shown in FIGS. 1-3, the present invention includes a tag 10, which has a suspension part 11 connected to a pieced part 12. One wall of the pieced part 12 of the tag 10 forms a slightly slanted spring part 15, and the spring part 15 is separated from the top wall at the top. The internal part of the pieced part 12 is hollow, which forms a space for the spring part 15. A reinforced rib 16 is placed in the middle of the pieced part 12 to increase its strength, and a locking slot 17 and a limiting part 19 are formed on the top of the pieced part 12. The two internal walls of the locking slot 17 has clip slot 18, and two pre-determined positions on both sides of the pieced part 12 has a positioning end 14 and blocking end 13.

There is a tool 20, which can be cylinder or rod, and a through slot 21 and a blocking part 23 is formed on top of the tool 20. The through slot 21 of the tool 20 can be connected to the pieced part 12 of the tag 10, and the blocking part 23 is connected to the two blocking ends 13 on two side of the tag 10. A positioning part 22 corresponding to the positioning end 14 of the tag is placed at the pre-determined location on the internal wall of the through slot 21, so that the positioning part 22 in the through slot 21 of the tool 20 may be locked to the positioning end 14 of the tag 10.

A locking component 30 has two locking ends 31 formed on the two ends of the locking component 30, so that when the locking component 30 is positioned in the locking slot 17 of the tag 10, the two locking ends 31 of the locking component 30 may be clipped to the clipping location of the tag 10. The two locking ends 31 of the locking component 30 can be clipped inside the clip slot 18 inside the locking slot 17, and the pre-determined location of the locking component 30 forms a limiting space 32. When the locking component 30 is connecting to the locking slot 17 of the tag 10, the limiting space 32 of the locking component 30 corresponds to the limiting part 19 of the reinforced rib 16 of the tag 10, so that when the locking component 30 is connected to the tag 10, both ends can be limited and clipped.

Through the above structure and design, the operation of the present invention is explained as follows.

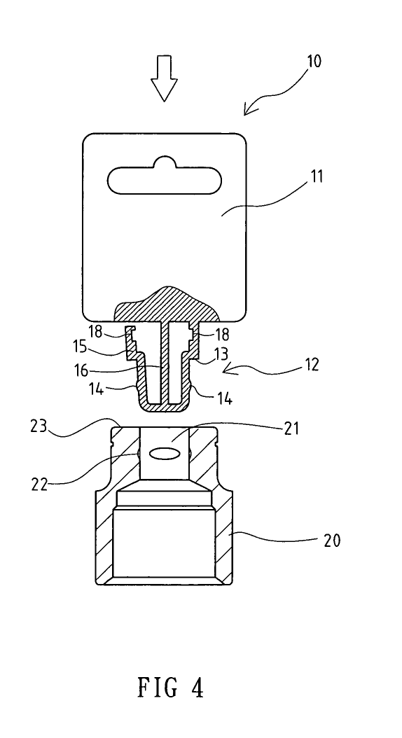

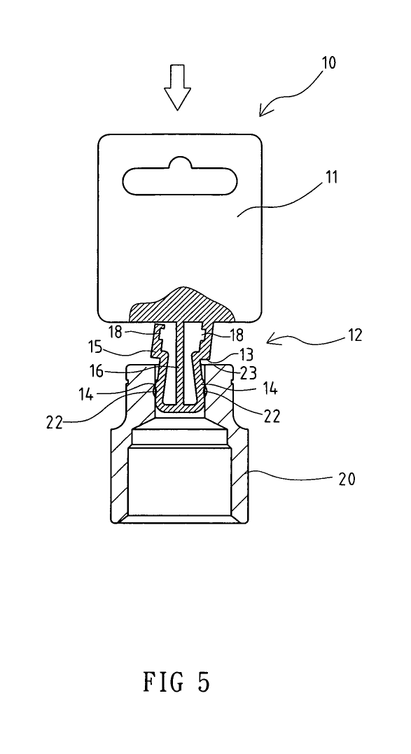

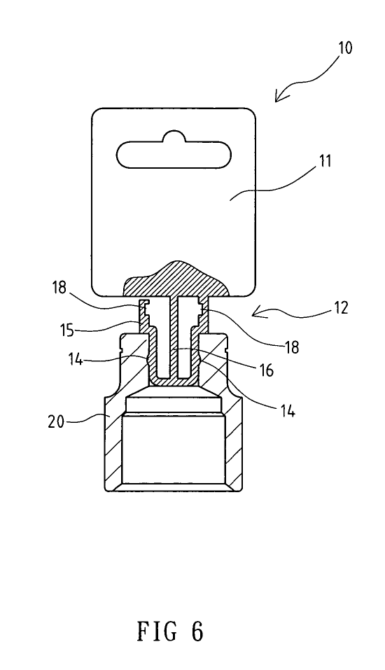

As shown in FIGS. 4-6, when the pieced part 12 of the tag 10 is connected to the through slot 21 of the tool 20, the positioning end 14 of the tag 10 is tightly pushed against the internal wall of the through slot 21 of the tool 20. The spring part 15 is slightly leaning outward in an angle, so that when it is connected to the containment slot 21, it increases its relative tightness and bends the spring part 15 of the tag 10 slightly (as shown in FIG. 5). When the tag 10 is placed in the containment slot 21 of the tool 20, the positioning end 14 on both sides of pieced part 12 of the tag 10 is locked in the positioning part 22 of the tool 20. Thus, the spring part 15 of the tag 10 returns to the original state (as shown in FIG. 6), which connects the tag 10 and the tool 20. As shown in FIGS. 1-3, when the locking component 30 is connected to the locking slot 17 of the tag 10, the pieced part 12 of the tag 10 is connected to the through slot 21 of the tool 20, which makes the locking slot 17 of the tag 10 show limited space. The locking ends 31 of the locking component 30 can be guided into the clip slot 18 of the tag 10, and the two locking ends 31 of the locking component 30 mentioned before correspond to the clip part of the tag 10. Moreover, the limiting space 32 of the locking component 30 is connected to the reinforced rib 16 of the tag 10, so that the tool 20 and the tag 10 can not be separated, which achieves the anti-theft effect of the present invention.

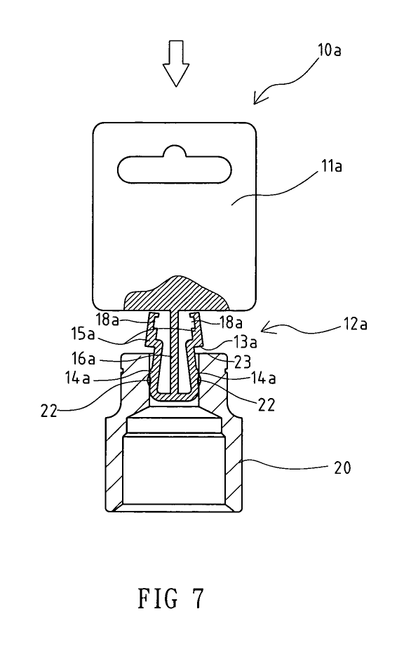

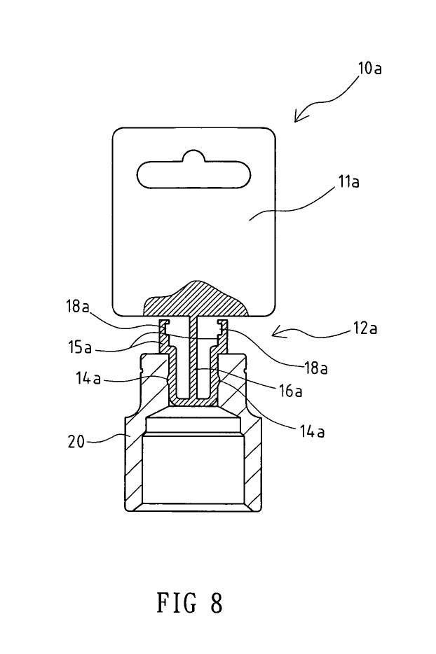

As shown in FIGS. 7-8, which is another embodiment of the present invention, the two walls of the pieced part 12a of the tag 10a can be a spring part 15a, and the reinforced rib 16a is the reinforced rib 16a that supports the spring parts 15a on both sides. When the pieced part 12a of the tag 10a is connected to the through slot 21 of the tool 20, the positioning end 14a of the spring part 15a on both walls of the tag 10a is tightly pushed against the internal wall of the through slot 21 of the tool 20. The spring part 15a on both sides of the tag 10a is bent slightly by force (as shown in FIG. 7). When the tag 10a is connected to the containment slot of the tool 20, the positioning end 14a on both sides of the pieced part 12a of the tag 10a is locked into the positioning part 22 of the tool 20, which makes the spring part 15a on both sides of the tag 10 restored to the original state (as shown in FIG. 8).

1-12. (canceled)

13. An anti-theft assembly comprising:
a tag having a suspension part and a pierced part integrally formed together, said pierced part having a hollow interior so as to define a locking slot, said tag having a pair of blocking ends extending outwardly respectively on opposite sides of said pierced part, said tag having a pair of positioning ends formed on opposite sides respectively of said pierced part below said pair of blocking ends, said pierced part having a spring member extending on at least one of said sides of said pierced part, said spring member having an upper end in spaced and separate relation to an upper wall of said pierced part;
a tool having a through slot extending from a top of said tool, said tool having a blocking part formed at said top of said tool, said pierced part received in said through slot, said pair of blocking ends abutting and blocking part of said tool, said through slot having a positioning element engaging at least one of said pair of positioning ends of said pierced part; and
a locking component having a locking end formed at one end theeof, said locking element positioned within said locking slot, said locking end overlying a portion of said pierced part, said locking component having a forward surface with a pair of ears overlying respectively a portion of said opposite sides of said pierced part.

14. The assembly of claim 13, said tool having a cylindrical shape.

15. The assembly of claim 13, said pierced part having a pair of clip slots formed respectively on opposite internal walls of said pierced part, said locking end of said locking component being slidable through at least one of said pair of clip slots.

16. The assembly of claim 13, said spring member being resiliently received in said through slot of said tool.

17. The assembly of claim 13, said pierced part having a reinforcing rib formed centrally therein, said spring member formed on both of said sides of said pierced part.

18. The assembly of claim 17, said reinforcing rib having a limiting part, said locking component defining a limiting space therein, said limiting space of said locking component contacting said limiting part of said reinforcing rib.

19. An anti-theft assembly comprising:
a tag having a suspension part and a pierced part integrally formed together, said pierced part having a hollow interior so as to define a locking slot, said tag having a pair of blocking ends extending outwardly respectively on opposite sides of said pierced part, said tag having a pair of positioning ends formed on opposite sides respectively of said pierced part below said pair of blocking ends, said pierced part having a spring member extending on at least one of said sides of said pierced part, said spring member having an upper end in spaced and separate relation to an upper wall of said pierced part; a locking component having a locking end formed at one end theeof, said locking element positioned within said locking slot, said locking end overlying a portion of said pierced part, said locking component having a forward surface with a pair of ears overlying respectively a portion of said opposite sides of said pierced part.

20. The assembly of claim 19, further comprising:
a tool having a through slot extending from a top of said tool, said tool having a blocking part formed at said top of said tool, said pierced part received in said through slot, said pair of blocking ends abutting and blocking part of said tool, said through slot having a positioning element engaging at least one of said pair of positioning ends of said pierced part.

21. The assembly of claim 19, said pierced part having a pair of clip slots formed respectively on opposite internal walls of said pierced part, said locking end of said locking component being slidable through at least one of said pair of clip slots.

22. The assembly of claim 19, said spring member being resiliently movable into said locking slot when a force is applied to a side of said pierced part.

23. The assembly of claim 19, said pierced part having a reinforcing rib formed centrally therein, said spring member formed on both of said sides of said pierced part.

24. The assembly of claim 23, said reinforcing rib having a limiting part, said locking component defining a limiting space therein, said limiting space of said locking component contacting said limiting part of said reinforcing rib.
